(19) United States
(12) Patent Application Publication
(10) Pub. No.: US 2002/0120432 A1
(43) Pub. Date: Aug. 29, 2002

(54) Method and apparatus for optimization of high-throughput screening and enhancement of biocatalyst performance

(76) Inventors: David Ager, Hoffman Estates, IL (US); John Aikens, La Grange Park, IL (US); Michael Flavin, Darien, IL (US); Eric Kirchhoff, Winfield, IL (US)

Correspondence Address: MCDONNELL BOEHNEN HULBERT & BERGHOFF, 300 SOUTH WACKER DRIVE, SUITE 3200, CHICAGO, IL, 60606, US

(21) Appl. No.: 09/927,214

(22) Filed: Aug. 10, 2001

Related U.S. Application Data
(63) Continuation-in-part of application No. 09/755,779, filed on Jan. 5, 2001.
(63) Continuation-in-part of application No. 09/737,204, filed on Dec. 14, 2000.
(63) Continuation of application No. 09/443,987, filed on Nov. 19, 1999, now Pat. No. 6,175,816.
(63) Continuation of application No. 08/862,840, filed on May 23, 1997, now Pat. No. 6,044,212.
(60) Provisional application No. 60/224,303, filed on Aug. 10, 2000.
(60) Provisional application No. 60/174,974, filed on Jan. 6, 2000.
(60) Provisional application No. 60/018,282, filed on May 24, 1996.

(51) Int. Cl. G06G 7/48

(52) U.S. Cl. 703/12

(57) ABSTRACT

A method and workstation for optimizing optimization of biocatalyst performance based on combinatorial chemistry, automation technology, and computer-controlled design is disclosed. The workstation includes a synthesizer, an analyzer, a robot and computer in communication with the synthesizer and analyzer. The computer includes one or more programs for regulating reaction parameters such as types of enzymes; amounts of enzymes; types of solvents/buffers; amounts of solvents/buffers; temperature; pressure; pH; types of substrates; time; enzyme—substrate ratio; and agitation (whether to agitate and the speed of agitation) and employs statistical methods for optimizing multiple reaction parameters and for designing optimized experiments for further investigation.

### REFERENCE TO RELATED APPLICATIONS

The current patent application claims priority to U.S. patent application Ser. No. 60/224,303 filed on Aug. 10, 2000 and entitled “Method and Apparatus for Optimization of High-Throughput Screening and Enhancement of Biocatalyst Performance.” This application incorporates by reference U.S. patent application Ser. No. 60/224,303 in its entirety. The current patent application claims priority to U.S. patent application Ser. No. 60/174,974 filed on Jan. 5, 2000 and entitled “Combinatorial Approach to Kinetic Resolution of Chiral Molecules.” This application incorporates by reference U.S. patent application Ser. No. 60/174,974 in its entirety. This application also is a continuation in part of U.S. patent application Ser. No. 09/755,779 filed on Jan. 5, 2001, pending. This application incorporates by reference U.S. patent application Ser. No. 09/755,779 in its entirety. This application also is a continuation in part of U.S. patent application Ser. No. 09/737,204 filed on Dec. 14, 2000, pending, which is a continuation of U.S. patent application Ser. No. 09/443,987 filed on Nov. 19, 2000, now U.S. Pat. No. 6,175,816, which is a continuation of U.S. patent application Ser. No. 08/862,840 filed on May 23, 1997, now U.S. Pat. No. 6,044,212, which claims priority to U.S. patent application Ser. No. 60/018,282 filed on May 24, 1996. This application incorporates by reference U.S. Pat. Nos. 6,175,816 and 6,044,212. This application also incorporates by reference U.S. patent application Ser. No. 60/018,282.

### BACKGROUND OF THE INVENTION

The present invention relates to optimization and, more particularly, to optimization of biocatalyst performance.

Many industrial processes are based on catalytic reactions. Enzymes that are isolated from natural sources have evolved to be efficient and selective catalysts for the chemical reactions that take place in living systems. These natural enzymes are often not well suited to these tasks due to overproduction or use of an unnatural substrate, poor substrate solubility, breakdown of unstable products, or competing chemical reactions. In addition, many industrial processes involve substrates, organic solvents, and other harsh reaction conditions that are not encountered in nature. Several common industrial applications for enzymes, or biocatalysts, include serving as catalysts for chemical synthesis, additives for enhancing laundry detergent performance, or the use in water treatment plants as bioremediators of potentially carcinogenic or toxic compounds. For industrial applications, enzymes can be engineered to carry out specific functions including, but not limited to, increasing activity and stability in non-aqueous solvents. Some examples of generating libraries of enzymes are shown in U.S. Pat. No. 6,218,163, WO 99/67420, and WO 00/01842. U.S. Pat. No. 6,218,163, WO 99/67420, and WO 00/01842 are hereby incorporated by reference in its entirety.

In combination with the isolation of new enzymes, engineering of natural enzymes to perform new functions has increased. Enzymes may be altered to perform a new and specific function as well as to enhance or remove an existing function. Rational protein engineering based on the site-directed mutagenesis of individual amino acids can be applied to achieve this goal. However, this requires a detailed knowledge about the structure-function relationship of the enzyme, which is seldom available and time consuming to obtain. In addition, the mutation of key residues may dramatically affect the stability of the protein. The application of rational protein design can be time-consuming and expensive. Moreover, screening of libraries containing numerous mutant enzymes to characterize modified catalytic functions and to determine optimal catalytic conditions is also laborious and expensive.

### SUMMARY OF THE INVENTION

Traditional high-throughput screening involves a time-consuming manual survey of many different reaction conditions with the examination of one variable at a time. Automated technology is much more efficient, allowing scientists to examine different reaction conditions simultaneously while working at a very small scale. Instead of producing chemical libraries, the output from APR provides libraries of assay conditions. Researchers can rapidly examine multiple variables and their interactions in a defined series of reactions to minimize the number of experiments necessary for optimization of the assay conditions. APR merges the automated capability and the small scale of combinatorial chemistry with statistical design of experiments (DoE). This technology can be applicable to the field of biocatalysis in several ways. APR greatly decreases the amount of time required for the high-throughput screening of mutant libraries and is also a valuable tool for designing and carrying out a finite number of experiments to optimize the performance of a biocatalyst.

### BRIEF DESCRIPTION OF THE DRAWINGS

The following discussion will make reference to the accompanying drawing figures, wherein like reference numerals refer to like elements in the various views, and wherein:

FIG. 1 is a diagram of the components of a preferred workstation for implementing the invention.

FIG. 2 is a block diagram illustrating the flow of commands and data between the computer and synthesizer, robotic arm and product analyzer of FIG. 1.

FIG. 3 is flow chart illustrating the sequence of steps in performing the preferred optimization routine using the equipment of FIG. 1.

FIG. 4 is an additional block diagram of the computer, synthesizer, robot, and analyzer.

FIGS. 5A-5G are an additional flow chart of the sequence of steps in performing the preferred chemical reaction optimization routine using the equipment of FIG. 1.

FIG. 6 is an example of a chemical equation using E009 enzyme.

FIG. 7 is a 3-dimensional contour plot of the conversion response with E009 enzyme being constant at 5 mg/2 mL.

FIG. 8 is a 3-dimensional contour plot of the conversion response with Phenylethyl Acetate being constant at 37.5 mM.

FIG. 9 is a conversion contour plot with E009 enzyme being constant at 5 mg/2 mL.

FIG. 10 is a conversion contour plot with the percentage of ACN being held constant at

### DETAILED DESCRIPTION OF THE PRESENTLY PREFERRED EMBODIMENTS

A different approach, known as directed evolution, can give rapid access to an enzyme with the desired properties. This process utilizes a variety of methods such as sequential random mutagenesis, error-prone mutagenesis or gene shuffling in combination -with high-throughput screening or selection to identify libraries of potential biocatalysts. Directed evolution does not require any prior knowledge of the structure-function relationship. The ultimate goal for this process is the production of a catalyst that enhances or removes a defined application-specific function of the natural enzyme. Examples of this function include a mutant protein with go increased activity, greater stability in organic solvent, or broader substrate specificity with respect to the native enzyme. An important element to a successful directed evolution program is the high throughput screening assay. The identification of the best suited mutant protein is highly dependent on the selected screening conditions.

The major steps of directed evolution include the selection of the gene, the creation of a variant library, insertion of the library into an expression vector, expression of the gene library to produce the mutant enzyme libraries, screening of the mutant enzymes for the property of interest, and the isolation of the gene corresponding to the improved variant properties so that the cycle can be repeated several times. The generation and screening of mutants with improved performance is carried out in iterative steps. After several cycles, the performance of mutant proteins should be optimal under the application-specific conditions.

The high-throughput screening assay must be designed to test the new or modified function of the biocatalysts. High-throughput screening may consist of a survival, heat evolution, or calorimetric assays so that a positive result is observed. The identification of the best biocatalyst is highly dependent on the screening conditions.

Biocatalysts may be applied to the chemical synthesis of fine chemicals. Advantages of biocatalysts over conventional synthetic methods include a decrease in resource efficiency as well as the reduction of waste. Biocatalysts offer the potential to reduce the unwanted byproducts that are generated by chemical synthesis. The use of biocatalysts with increased stability or catalytic activity would replace chemical reaction that are difficult to achieve with standard methods and eliminates high volumes of hazardous waste.

Directed evolution is severely limited by both the time involved in screening mutant libraries for a specific function and in the optimization of the assay conditions for a biocatalyst. High-throughput screening of mutant libraries may involve hundreds of substrates. Additional time may be required to synthesize substrates that are not commercially available. When a positive result is observed for the screening assay, multiple variables must be examined to determine the conditions for optimum enzyme activity. The variables that may affect enzyme activity are numerous and not all will significantly contribute to the desired function. The stability of the protein may be an issue when an organic co-solvent is necessary or if the production of a biocatalyst with activity in organic solvent is the desired goal. Examples of solvents include MeCN, MeOH, EtOH, DMF, H₂O, aqueous buffers and mixtures thereof. Each substrate that exhibits a positive screening result must be explored in greater detail to determine the conditions for optimum enzyme activity.

Thus, Automated Process Research (APR) technology is a powerful tool for the pharmaceutical industry to generate lead compounds as potential drug candidates. This technology differs from traditional methods by utilizing automated equipment coupled with the statistical design of experiments to rapidly synthesize diverse libraries of chemical compounds. In the past, automated technology has been confined to defined areas of chemical synthesis. However, APR technology has unlimited potential and can be applied to any repetitive task that is performed in the laboratory.

1. APR and High-throughput Screening of Mutant Libraries

The high-throughput screening of substrates for improved function may potentially require hundreds of reaction assays. The automated equipment may be of great use in facilitating this screening process. There may be various methods for the identification of a positive assay result, depending on the function of the protein that is being enhanced or removed. One method of detection is a colorimetric assay. The chromophoric properties of the substrate or the presence of color indicators would allow the detection of a positive result. In some cases, a visible screening assay may not be possible, depending on the function of the mutant library or the nature of the substrate. The high-throughput robotics of the APR equipment would be an efficient way to analyze the product formation by chromatography. In addition, APR can significantly reduce the time and costs associated with the traditional screening of substrates.

The statistical design of experiments may aid in the screening of mutant libraries. For example, the goal of directed evolution might be to generate a protease that exhibits increased activity and stability in organic solvent. A finite number of experiments can be designed at several concentrations of organic solvent to determine the effect of organic solvent on enzyme activity.

2. Rapid Optimization of Biocatalyst Performance.

Once positive results have been obtained from the high-throughput screening experiments, the optimization of the assay conditions for each of the positive results will be necessary. The optimization of biocatalyst performance can be carried out by APR, combining the use of automated equipment with the statistical design of experiments. Enzyme activity is affected by numerous factors including the concentrations or presence of substrates, activators, inhibitors or co-factors as well as the effects of salts, buffers, pH, temperature, solvent composition, ionic strength, and perhaps, the interactions with other proteins. The nature of the buffer may be important since some buffers can act as inhibitors of the enzymes. Salts may be essential for activity, especially with enzymes from extreme environments such as those found in thermophilic or halophilic bacteria. Metal ions essential for activity may be complexed by the buffer. To achieve maximum catalytic activity, one or more of these variables should be optimized, preferably all.

Three basic experimental designs can be utilized to enhance the biocatalyst activity. The goal of the first experimental plan would be to determine which experimental parameters, or variables, contribute to the optimization of enzyme activity. This can be accomplished with a Plackett-Burman design. This model calculates a finite number of experiments to screen all variables that are entered over user-defined ranges. The statistical design is coupled with the automated equipment to carry out the experiments and the results may be plotted, for example, in a bar graph format. Many variables may be statistically insignificant within the user-selected ranges and can be held constant in future experimental designs. The Plackett-Burman design does not provide information about the optimum assay conditions, but instead determines the parameters that are critical for enzyme activity. In the second experimental plan, a fractional factorial design is implemented to provide a rough estimate of the optimum conditions for enzyme activity. The parameters that were insignificant within experimental plan 1 are held constant and the others are varied over a broad range. The results may be displayed, for example, in a table format. A more accurate catalytic performance enhancement can be determined with a third experimental plan, the surface response design. The parameters that are less significant to achieve optimum activity in the second experimental plan are held constant so that the more critical variables can be optimized.

In some cases, the substrates that may be desired for the high-throughput screening experiments may not be commercially available. APR technology may then be applied to chemical process development for the rapid optimization of the desired substrate. The use of synthetic substrates for screening libraries of mutant proteins may be necessary. For example, APR can be utilized to examine the effect of carbon chain length on the enzyme activity.

The use of statistically designed experiments coupled with automated equipment can greatly facilitate the identification of enhanced biocatalytic performance. The examination of one variable at a time would require a vast number of experiments and the optimum assay conditions would not be easily obtained. This process would then be repeated for each substrate that exhibited a positive result within the high-throughput screening. APR can greatly reduce the time and cost involved in this process. Whether screening mutant libraries for activity, optimizing assay conditions, applying chemical process development, or reformulating drugs, APR identifies crucial parameters. By employing DoE, cost consequence can be identified for process variables. Automated process research is a valuable business/technology platform with many applications.

3. System Overview

In this description, the novel application of automated technology to optimization of biocatalyst performance is disclosed. The basic concept is to have a machine perform the repetitive procedures involved in process development in order to increase the efficiency with which data can be collected and analyzed for a given biocatalyst.

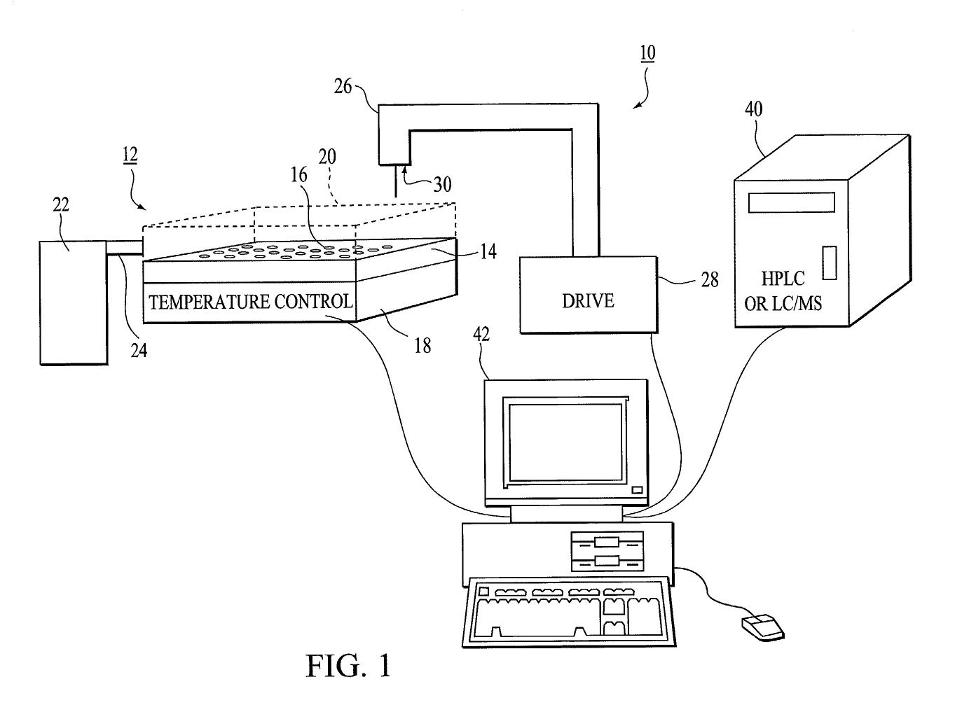

A preferred workstation for implementing the invention is shown in FIG. 1. The workstation 10 includes a synthesizer 12 having a reaction block 14 having, for example, 96 reaction wells 16. In experiments which require adjustment of the temperature, the synthesizer 12 may be equipped with a temperature control system 18 for adjusting the temperature of the block 14, so as to control the temperature of the wells 16. Preferably, the temperature control system 18 has the capability of controlling the temperatures of the wells individually, so that the conditions in the wells 16 can be customized. The synthesizer may include a lid or cover 20. In one embodiment, a source 22 of nitrogen or argon gas or any appropriate gas mixture may be connected to the synthesizer 12 via a conduit 24, if necessary, which enables a control of the atmospheric conditions above the wells. Mixing mechanisms such as a vortex mixer or an orbital shaker can be built into the synthesizer 12 to assist in the mixing of the reagents in the wells.

The synthesizer 12 further includes a robotic arm assembly 26 which has pipetting capability for selectively adding quantities of one or more reagents to the wells 16. The robotic arm assembly 26 includes an X-Y drive mechanism 28 or other suitable means for controlling the position of the pipetting tip portion 30 of the arm assembly relative to the wells.

In one embodiment, the analytical functions are manually performed by the operator by examining the samples (e.g., if the pH is the subject of analysis and if a chemical is added to the wells to indicate the pH of the reaction based on the color of the well, the pH may be manually determined by visually examining the color change of the well). Alternatively, the station 10 may includes an analytical instrument 40 for conducting an analysis of the reaction. The analytical instrument 40 varies based on the requirements of the analysis. In one embodiment, an HPLC machine (for example, a chiral HPLC machnine) is used to examine at least one aspect of the reactions in the wells. This one aspect may include the product of the reaction, the by-products of the reaction, the unreacted substrate, and the enantiomer selectivity.

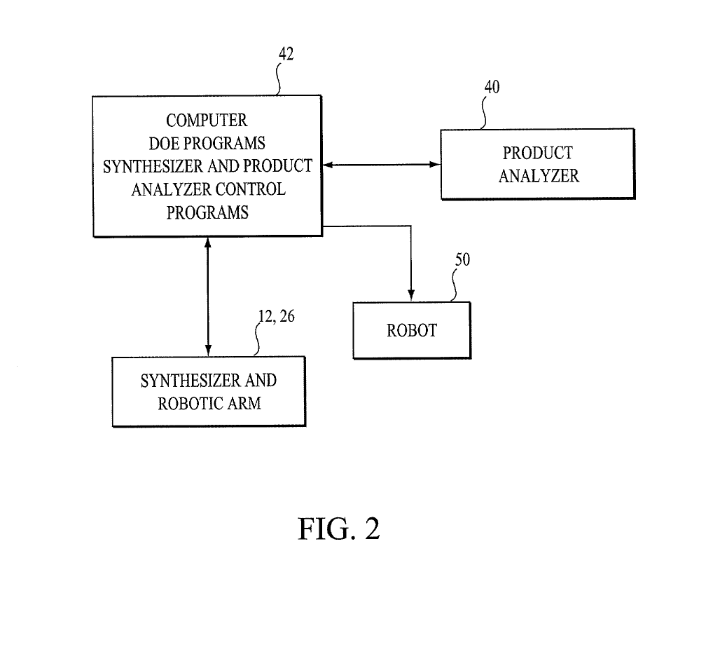

The products from the synthesizer 12 can be either manually loaded into the analytical instrument 40, or loaded automatically with the assistance of suitable robotic arms or other equipment, represented by robot 50 in FIG. 2 or other suitable mechanical system.

The operation of the synthesizer 12 and analytical instrument 40 may be controlled by a computer 42, as shown in the block diagram of FIG. 2. The computer 42 regulates the environmental conditions in the synthesizer 12 such as by controlling the temperature of the wells 16. The quantity and type of reagents added to the wells are also controlled by the computer 42, as is the position of the arm 26 relative to the wells 16. The computer 42 further initiates and controls the analysis of the reaction in the analytical instrument 40, and receives the analytical data from the instrument 40. The computer 42 further implements a design of experiment program (DoE) that is used to identify the optimal conditions for the reaction being studied, as described below. It will be understood that some or all of the control functions of the computer 42 may be integrated into one or more of the individual components of the system 10. Where the products are automatically loaded into the product analyzer 40, the computer 42 controls a robot 50 to perform this task.

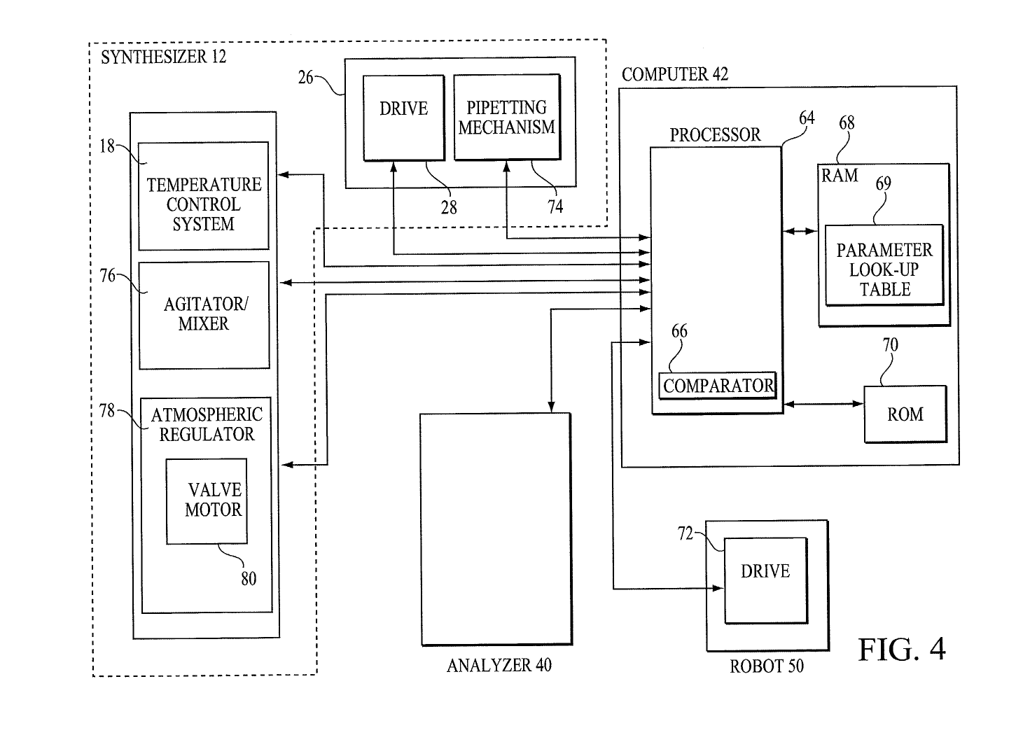

An additional block diagram of the computer, synthesizer, robot, and analyzer is shown in FIG. 4. The computer 42 contains a processor 64 which communicates with non-volatile (read only memory, ROM 68) and volatile (random access memory, RAM 70) memory devices. The processor 64 also has a comparator 66 for comparing values. The processor 64 executes a computer program. The computer program is stored in the ROM 70 and executed either in the RAM 68 or the ROM 70.

The processor 64 communicates with various subcomponents of the synthesizer 12, the analyzer 40 and the robot 50. The synthesizer contains a temperature control system 18 which controls the temperature of each of the individual wells of the block. The processor sends a command to the temperature control system 18 specifying a certain temperature for a particular well. The synthesizer also contains an agitator/mixer 76 which agitates or mixes the individual wells. There are two different methods of agitating or mixing. The first method is to agitate the block as a whole whereby each of the wells are shaken at the same rate. To do this, the entire reaction block is agitated at one rate. The second method is to mix each of the individual wells at different rates. Each well is equipped with at metal stirrer underneath the well. Inside the well is to a TEFLON-coated magnet which follows the motion of the metal stirrer underneath the well. In this manner, the individual well is stirred based on the rate at which the metal stirrer is rotated. The rate of rotation is set by the processor 64.

The synthesizer also contains an atmospheric regulator 78 which protects the components in the wells if the components are sensitive to oxygen, carbon monoxide, or other materials in the environment in proximity to the well. Nitrogen, argon gas or any appropriate gas may be dispensed from the source 22 through the conduit 24 based on a valve which is controlled by the valve motor 80. The valve motor is controlled by the processor 64.

The synthesizer further contains a drive 28 for moving the robotic arm assembly 26. As described above, the robotic arm assembly 26 has pipetting capability for selecting, obtaining and dispensing one or more reagents. The pipetting capability is performed through a pipetting mechanism 74 which draws reagents through the pipetting tip portion 30 and stores one or more reagents in the robotic arm assembly 26. Subsequently, the one or more reagents are dispensed via the pipetting mechanism 74 into the wells. Both the drive 28 and the pipetting mechanism 74 are controlled by the processor 64.

The analyzer 40 and robot 50 are in communication with the processor 64 as well. The processor 64 controls the drive 72 of the robot 50 which extracts samples from each of the wells. The samples are transferred to the analyzer 40 which analyzes one aspect of the mixture including the product of the reaction, the by-products of the reaction, the unreacted substrate, and/or the enantiomer selectivity.

4. Detailed Methodology

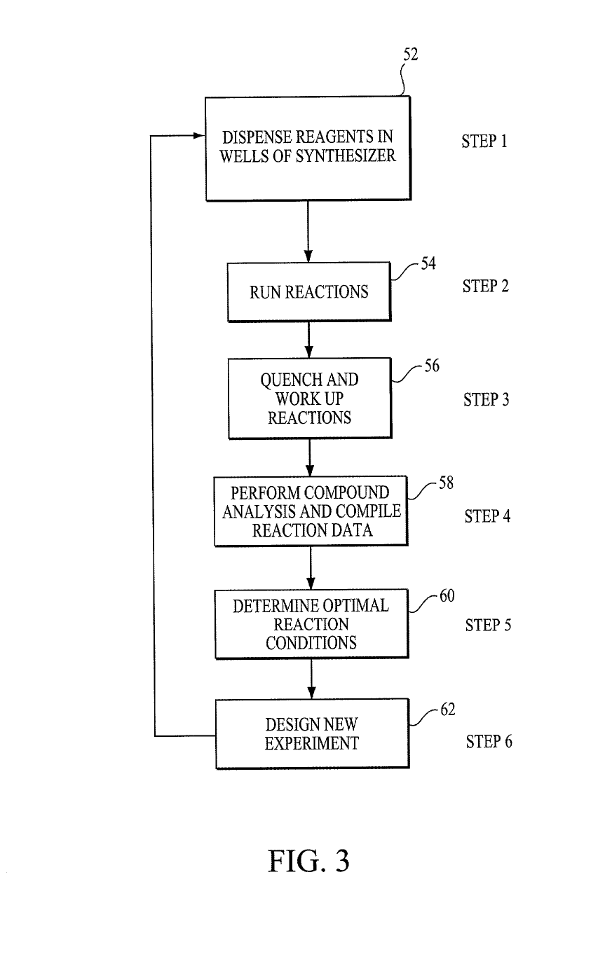

Referring to FIG. 3, there is shown a block diagram of the methodology for the reaction optimization and will be described in conjunction with the system in FIG. 1. As shown at block 52, the reagents are dispensed in the wells of the synthesizer.

Variables which may be varied in a set of experiments include, but are not limited to: types of enzymes; amounts of enzymes; types of solvents/buffers; amounts of solvents/buffers; temperature; pressure; pH; types of substrates; time; enzyme—substrate ratio; and agitation (whether to agitate and the speed of agitation). The values for the first set of experiments (see block 49 of FIG. 3) may be chosen through a variety of ways. For example, the values may be chosen manually by the operator. Alternatively, a range of values for the variables may be chosen and the values for each of the 96 initial experiments may be chosen randomly or periodically with the range of values available. For example, given the number of enzymes available for testing, the range of temperatures, the types of solvents/buffers, amounts of solvents/buffers, the substrates available, etc., an initial set of experiments may be chosen.

After the values for the initial experiments are chosen, the experiments are run. In Steps 1-3 (blocks 52, 54 and 54 of FIG. 3), the synthesizer 12 containing a 96-well reaction block 14 is used for the reaction of interest, and the robotic arm 26 can be programmed to dispense precise amounts of reagents into each well (see FIG. 1). Each well 16 contains a separate experiment. Depending on the environmental conditions necessary for the experiments (temperature/pressure/etc.), the environmental conditions within each well can be controlled and the contents of each well can be efficiently mixed. The reagents can then be quenched and worked up using the same robotic technology, as shown at step 3 (block 56) of FIG. 3. For example, if the reagents require a particular temperature, pressure or time period, the computer sends this information to the synthesizer to create the predetermined conditions for the experiment. This process alleviates the operator from performing repetitive tasks and increases the efficiency with which information can be gathered.

Once the 96 reactions are completed, at step 4, as shown at block 58 of FIG. 3, the tasks of compound analysis and data compilation begin. The analysis, as discussed previously, may be manual or automated. Manually, the operator may examine the reaction wells for a particular characteristic. For example, the operator may examine the color of the well to determine the extent of the reaction by examining a change in pH. The operator may then rate each of the samples as “good” or “bad” or rank them in order from “best” to “worst.” Alternatively, the analyzer 40 may automatically examine the samples. The success of each of these 96 reactions can be evaluated using the analytical techniques which was already developed for the parent reaction. For example, HPLC (High Pressure Liquid Chromatography), and in particular chiral HPLC, might be the analytical method of choice. In this case, the reactions would be manually or automatically transferred to vials which fit in an HPLC autosampler 40. Alternatively, an LC/MS machine or a gas chromatography machine may be used. The reactions may be analyzed for at least one component including, for example, the products of the reaction, the by-products of the reaction, the unreacted substrate, and the enantiomer selectivity (whether (R) or (S) enantiomer).

At this point (step 5), the results are compiled and analyzed. In one embodiment, in order to design the next set of experiments, the data compiled in step 4 is analyzed to determine common characteristics of a desired response. The analysis, in a preferred embodiment, is performed automatically by the computer 42. The analysis may include a two-step process: (1) determining the “success” or “failure” of each of the experiments; and (2) determining common characteristics of the “successful” experiments. For example, if the desired outcome of the experiments is enantiomeric selectivity (either (R) or (S)), the wells are examined to determine the reactions that resulted in good enantiomer selectivity. In addition, if other desired outcomes are of interest as well, such as product yield or time of reaction, the determination of whether an experiment is a “success” may account for those variable(s) as well.

The analysis may then focus on determining the common characteristics of the experiments which were deemed “successful” (such as desired enantiomer selectivity). For example, the analysis may determine common traits for the input variables for the “successful” experiments, such as temperature, pressure, agitation, solvent, amount of catalyst, substrates, buffer, salts, pH, ionic strength, activators, inhibitors, etc.). These common traits may specify a certain temperature range, pressure range, etc. for the “successful” experiments. Alternatively, the analysis may focus on a “best” experiment/experiments and analyze the input variables for the “best” experiment/experiments.

Once a statistical analysis of the data is performed, the statistical analysis is then transferred (either manually or automatically) to a means for designing the next set of experiments (step 6). The designing of the next set of experiments depends on the statistical analysis, as discussed more fully below. As merely one example, the next set of experiments may be chosen based on the common characteristics determined in step 5. Specifically, the next set of experiments may be chosen from the ranges of values (e.g., temperature, pressure, amount of catalyst, etc.) that were determined from the “successful” experiments. The next set of experiments may be evenly distributed within the ranges of values determined in step 5. Alternatively, the next set of experiments may be randomly chosen within the range of values determined in step 5. The concept of statistical design of experiments (DOE) may therefore be applied to aid in experimental design. In an alternate embodiment, the next set of experiments may be designed around the “best” experiment wherein the input variables for the “best” experiment may serve as the basis for the ranges of the input variables for the next set of experiments.

Commercially available computer programs can control the reaction conditions utilized by the synthesizer, perform statistical analyses and design the next set of experiments to conduct the most effective DOE study. One such program is Design Expert by Stat Ease Corp. in Minneapolis, Minn., which uses a linear regression analysis. Specifically, the computer program can analyze the data obtained from the analyzer to generate common characteristics from the data (such as linear regression analysis), to determine a range of “good” samples. Alternatively, the computer program may determine the “best” (based on established criteria) sample, or to determine the “worst” sample. The computer 42 can then correlate the data obtained and extrapolate to propose new experiments. The system may then iterate to subsequently confirm the proposed optimal conditions. Specifically, the computer program can take the common characteristics generated from the statistical analysis and propose new experiments based on the trends. Alternatively, the computer program can design a new set of experiments localized around the reagents/conditions of the “best” sample. This iteration is represented by the arrow 51 in FIG. 3. Basically, a new and potentially more narrowly circumscribed set of parameters (including types of enzymes, amounts of enzymes, types of solvents, amounts of solvents, time of reaction, or environmental conditions) are programmed in the synthesizer and robotic arm, and the process is repeated. For example, the range of values for the parameters in the new set of experiments may be different (either narrower or a different range) from the previous range of values. This procedure could iterate several times, until the optimal reaction conditions are determined with the desired level of precision. Alternatively, the procedure (steps 1-5) could just be performed once, with the computer 42 identifying which of the reaction wells 16 had the most favorable conditions for the reactions.

Several types of methodologies may be used to design the next set of experiments (see step 6 of FIG. 3) including the Monte Carlo method, the SDO method, and the “weights” method. Using a program which utilizes the Monte Carlo method, for instance, the operator can define the space of parameters to be analyzed, run a series of random preliminary experiments in this space, define a new space of parameters using the best of these preliminary experiments, run additional experiments in the new space and continue this process until no further improvement is observed. For example, the operator defines a space of reaction parameters for each experiment, such as temperature, pressure, agitation, solvent (e.g., organic, H₂O, etc.), type of catalyst, amount of catalyst, substrates, buffer, salts, pH, ionic strength, activators, inhibitors, and/or time period for reaction, and then performs several preliminary random experiments using the synthesizer. The analyzer data concerning the product yield, by-products, unreacted substrate, enantomer selectivity, for instance, are then analyzed by the computer to determine the “successful” experiments. Based on the “successful” experiments, the program then utilizes the statistical method to generate a new space of parameters (e.g., temperature, concentration, pressure and time) for further experimentation. This new space of parameters may be based on values for the parameters from the “successful” experiments (e.g., the new space for the temperature parameter may be based on the temperatures from the “successful” experiments). A new set of reactions are then performed based on the new space of parameters and the resulting data from the experiments for the new space of parameters is then stored and processed by the Monte Carlo method as before. This process can be repeated until no further improvements are obtained.

Alternatively, a program which utilizes the SDO method generates a set of experiments in all of the variables of interest for the operator. When these experiments have been run, the experiment that gave the worst result is identified among the set. This experiment is then discarded and replaced with a new experiment. When the replacement experiment has been run, the worst of the set is again identified and discarded. This process continues until no further improvement is observed. For example, the operator performs preliminary experiments with the synthesizer using SDO variables of interest. The data, in combination with the variables, are then analyzed by the program. The program would then eliminate the experiment with the worst result and generate a new proposed experiment. This process is repeated until no further improvements in product yield, for instance, are obtained.

Another method to analyze the data in the newly created table is by first determining the “weights” for each of the reaction parameters. The reaction parameters may include temperature, pressure, agitation, solvent (e.g., organic, H₂O, etc.), amount of catalyst, substrates, buffer, salts, pH, ionic strength, activators, inhibitors, and/or time period for reaction. Prior to execution of the program, the operator assigns “weights” based on importance of each reaction parameter. In this manner, the results of each of the wells can be assigned a total “score” by multiplying the reaction parameters by the “weights” and adding them. Each of the results for an individual well can then be tallied. For parameters which are of great importance, those parameters are weighted accordingly. For parameters which are more desirable when they are lower in value, e.g. the time of reaction, the result of multiplying the weight by the parameter can be inverted, and then added to the total to determine the “score.”

The entries can then be arranged based on the score. The processor 64 then displays the results of the raw data and the “scores.” At each step in the methodology, the display can be updated to inform the operator of the current reaction. For example, when the processor 64 commands or receives information from the synthesizer 12, the analyzer 40 or the robot 50, the display can be updated to indicate the current operation.

Based on the highest ranked “score,” the suggested bounds for the next set of experiments may be determined. For example, if the temperature of the reaction is determined to be an important parameter, the temperature value of the highest ranked “score” is used as a base value for the temperature bounds for the next set of experiments. The suggested parameters are then displayed to the operator.

This automated process development technology allows a vast array of data to be collected and interpreted. Many combinations of reaction variables can be investigated in a short time period. Using the current manual technology, only a local optimization is found because it is too time consuming to investigate every set of reaction conditions. With the new automated technology presented here, a large number of statistical data points can be collected. In essence, a global optimization is found. The amount of data generated by this process is limited only by the number of variables that can be envisioned for a given reaction.

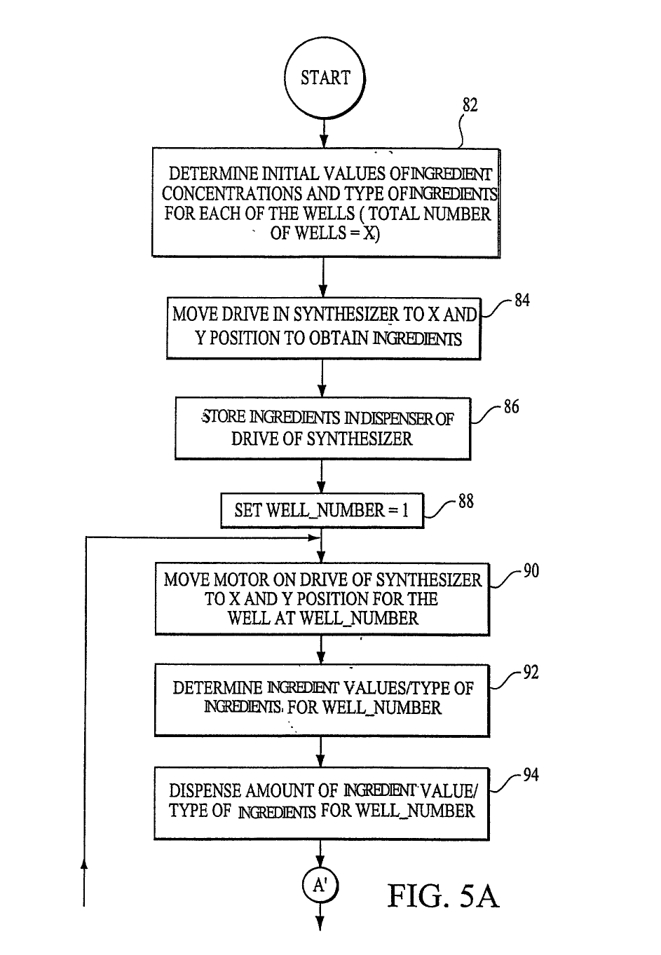

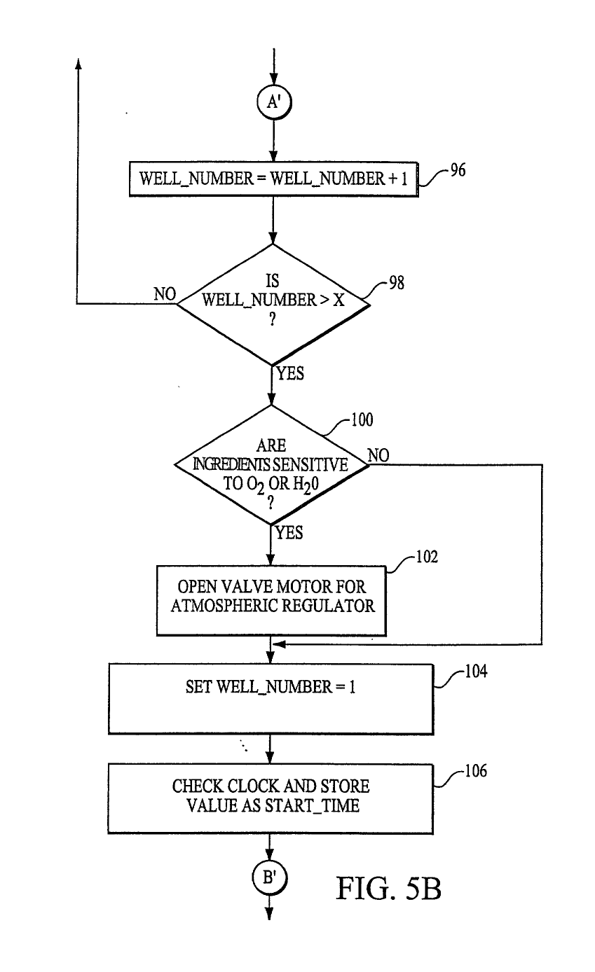

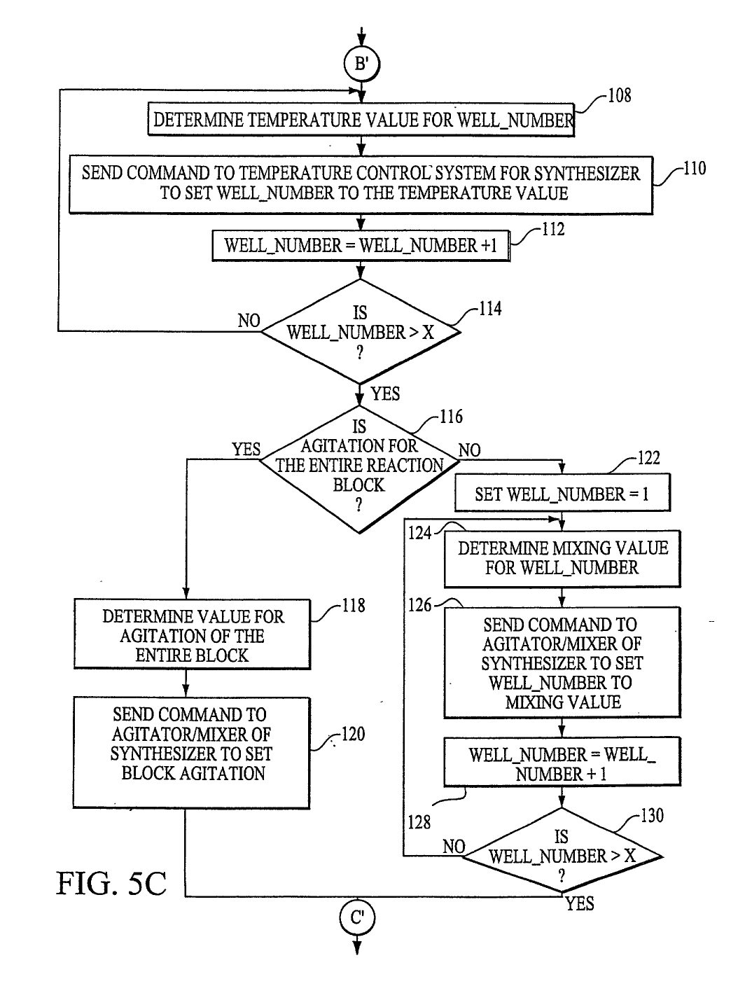

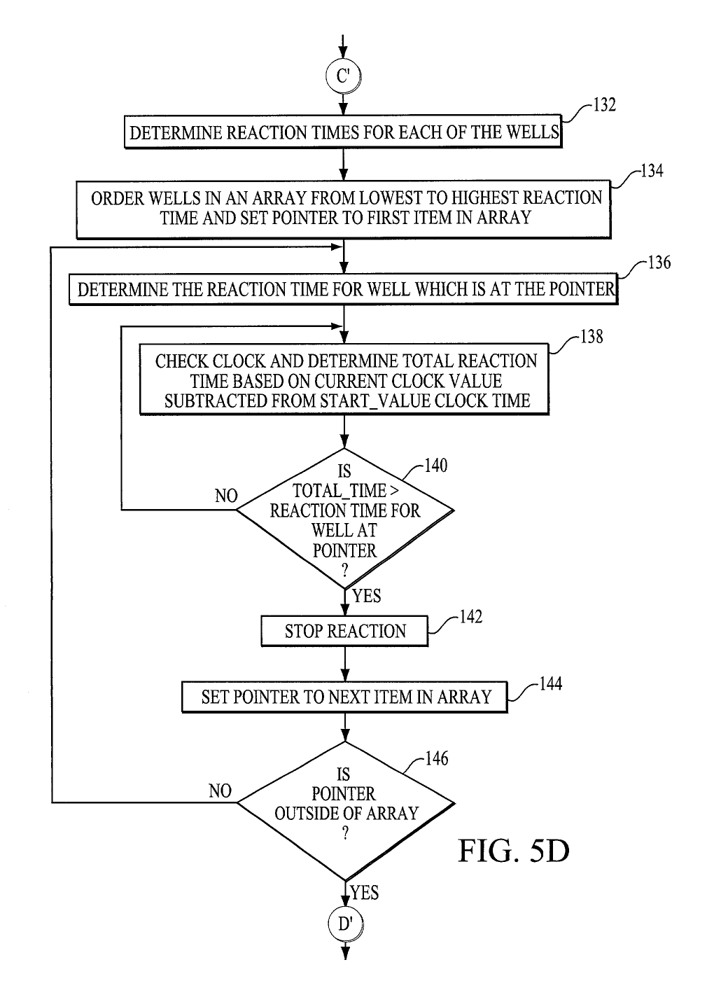

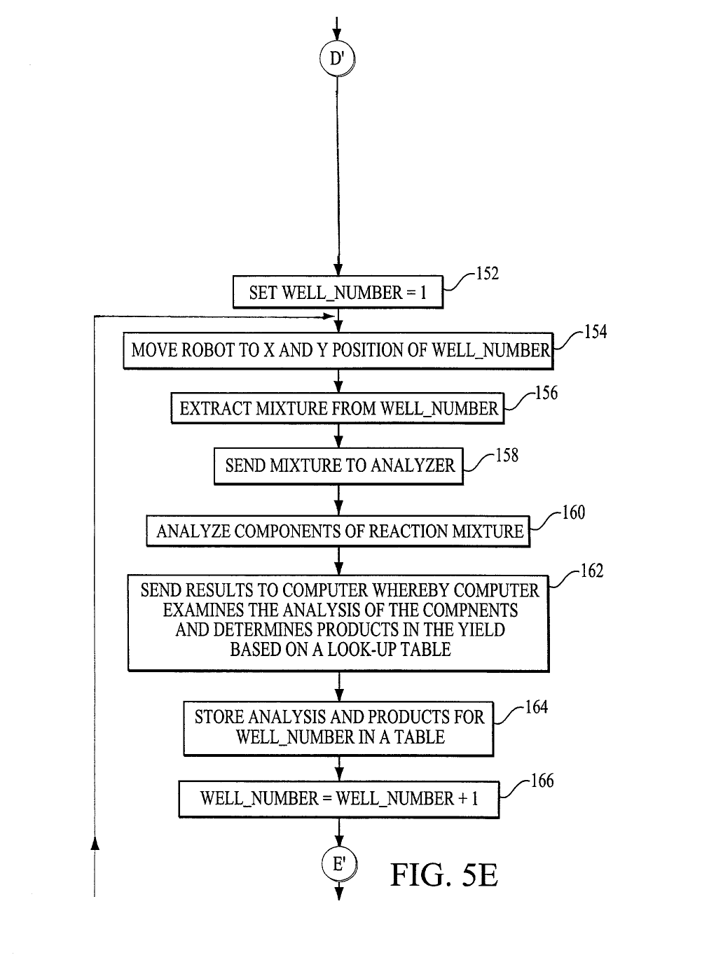

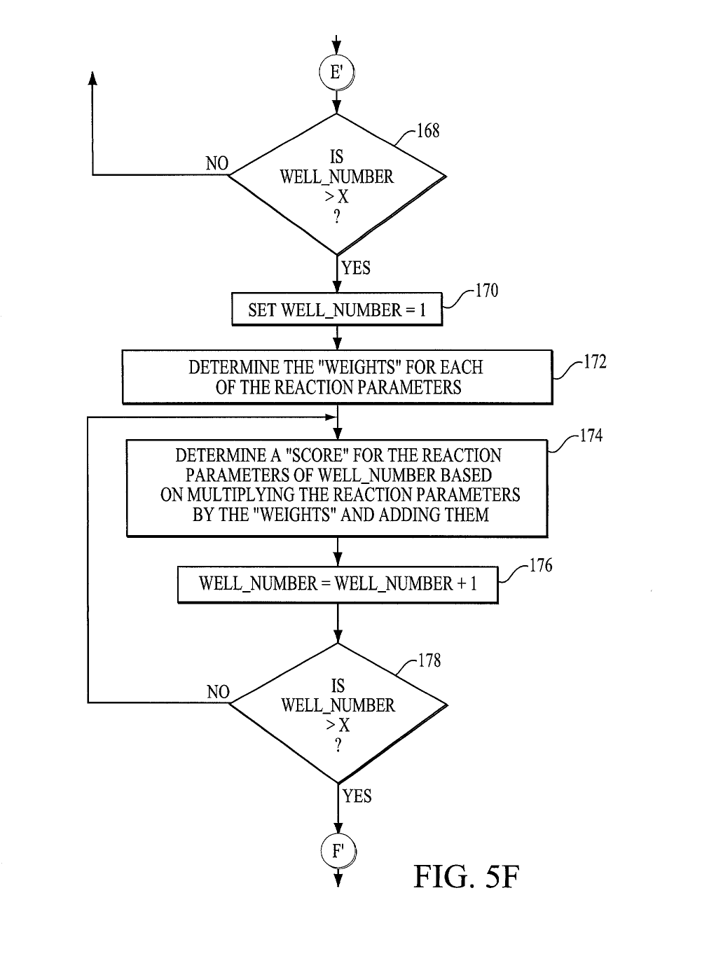

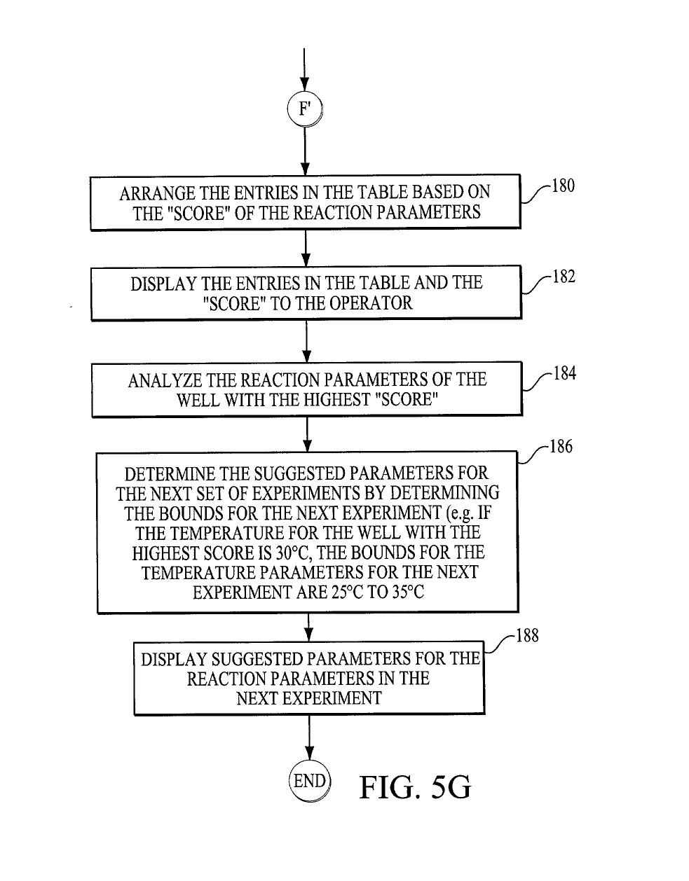

FIGS. 5A-5G are an additional flow chart of the sequence of steps in performing the preferred reaction optimization routine. The program which executes the operation of the automated sequence of operations, as stated above, is resident either in RAM 68 or ROM 70. The program first determines the initial values of ingredient concentrations and type of ingredients for each of the wells 82. Different ingredients may include enzymes, substrates, co-factors, solvents, etc. This is done so that the processor 64 can command the pipetting mechanism 74 to obtain the correct ingredients and the approximate amount of ingredients for use in all of the wells. As shown in FIGS. 5A-5G, the total number of wells is designated as “X.” As discussed above, one reaction block 14 has, for example, 48 reaction wells 16. Reaction blocks with less or more reaction wells may be used as well.

The processor 64 then instructs the drive 28 to a particular x and y position to obtain the ingredients 84. The pipetting mechanism 74 then stores the ingredients in the dispenser of the drive of the synthesizer 12, as shown at block 86 of FIG. 5. Then a loop is executed for each of the wells 16, with the well_number set equal to 1, as shown at block 88 of FIG. 5. The processor 64 moves the motor of the drive 28 to the x and y position of the well 90, the ingredient values and type of ingredients are determined by the processor 92, and the ingredients are dispensed into the well, as shown at block 94 of FIG. 5. The ingredient values and types of ingredients are determined by a parameter look-up table 69 (which contains all of the relevant parameters for the experiment) in the memory of the microprocessor. The ingredient values and types of ingredients may be based either on operator input or based on the optimization scheme described subsequently. The well_number is incremented by 1, as shown at block 96 of FIG. 5. If the well_number is greater than the total number of wells (X), then the loop is exited, as shown at block 98 of FIG. 5. Otherwise, the flow chart of FIG. 5 goes to block 90.

Alternatively, the pipetting mechanism, rather than storing the ingredient in the dispenser in one step and dispensing in another step may alternatively store the ingredient and dispense, sequentially for each well. Further, rather than automatic obtaining and dispensing of the ingredient, the operator may manually input the ingredient values into the wells.

Prior to execution of the program, an ingredient-properties look-up table is created which determines, for a specific ingredient, whether the ingredient is sensitive to any other items, such as oxygen or water. This ingredient-properties look-up table may be separate and distinct from the parameter look-up table 69, or may be combined for operator convenience. Based on the ingredient-properties look-up table, if the ingredient is sensitive to oxygen or water 100, the processor 64 opens the valve motor 80 to dispense either nitrogen or argon gas as shown at block 102 of FIG. 5. The well_number is set equal to 1, as shown at block 104 of FIG. 5. Then, the clock for the processor 64 is checked with the value stored as the start time of the experiment 106. A loop is then entered to set the temperatures of each of the wells. The temperature is determined for each well 108 by the parameter look-up table 69. The temperature in the parameter look-up table 69 is either based on operator input or based on the optimization scheme described subsequently. The processor 64 sends a command to the temperature control system 18 to set the temperature value 110. The well_number is incremented by 1, as shown at block 112 of FIG. 5. If the well_number is greater than the total number of wells (X), then the loop is exited, as shown at block 114 of FIG. 5. Otherwise, the flow chart of FIG. 5 goes to block 108.

The agitation/mixing of the synthesizer is next initialized based on whether the individual wells are mixed at different rates or whether the entire reaction block is agitated at the same rate, as shown at block 116 of FIG. 5. If the agitation is at the same rate, the program determines the block agitation from the parameter look-up table 118 and sends a command to the agitator/mixer 120. If the agitation is at different rates, the program enters a loop, with the well_number set equal to 1 as shown at block 122 of FIG. 5, and determines the agitation from the parameter look-up table for each well 124 and sends a command to the agitator/mixer 126. The well_number is incremented by 1, as shown at block 128 of FIG. 5. If the well_number is greater than the total number of wells (X), then the loop is exited, as shown at block 130 of FIG. 5. Otherwise, the flow chart of FIG. 5 goes to block 124. In addition to mixing, the pH (which may be one of the parameters) in the wells may be modified using a pH machine.

The reaction times are then determined for each of the wells, as shown at block 132 of FIG. 5 based on data in the parameter look-up table 69. The wells are ordered in an array based on the reaction time, from lowest to highest with a pointer set to the first item in the array, as shown at block 134 of FIG. 5. The reaction time is determined for the well which is at the pointer, as shown at block 136. The reaction times are then checked based on checking the clock from the processor 64 and subtracting the time from the start value 138. When the reaction time has been exceeded for a particular well, as shown at block 140, the reaction is stopped 142. Stopping the reaction can be done in several ways including removing denaturing the enzyme or removing aliquots from the wells as discussed below. The pointer is set to the next item in the array, as shown at block 144. As shown at block 146, if the pointer is outside of the array, the flow chart goes to block 152. Otherwise, the flow chart goes to block 136.

After the reaction, the components of each of the wells 16 can be removed from each of the wells, sent to the analyzer 40 and analyzed. The well_number is set equal to 1, as shown at block 152 of FIG. 5. The processor 64 signals the drive 72 of the robot 50 to move to an x and y position 154, extract mixture from the well 156, and send the mixture to the analyzer 158. The analyzer 40 then analyzes the reaction mixture for a predetermined criteria, as shown at block 160, and sends the results to the processor 64. Some examples of predetermined criteria include: smell; viscosity; texture; time of processing; temperature of processing; pressure of processing; cost of ingredients; presence of certain ingredients; amounts of certain ingredients, etc. In the perfume example, the analyzer may be an electronic nose. The electronic nose may analyze the headspace of a particular well and generate data associated with the “smell” the electronic nose senses.

The results from the analyzer(s) may be sent to the computer for examination and comparison with a look-up table, as shown at block 162. For example, in the flavor component context, if the analyzer registers the components of the well (i.e., the types and amounts of components), the computer may take this data and compare it with a look-up table and assign a value to results. If certain components or certain amounts of components are desired, the computer may assess a value, a determination of “good” or “bad,” or some other evaluation of the well based on comparison of the components of the well with the values in the look-up table. As another example, if a certain smell is desired, the headspace may be analyzed to determine its components/amounts of components and compared with desired components/amounts of components.

The processor stores the results in a table, as shown at block 164, and continues obtaining data for each of the wells. The well_number is incremented by 1, as shown at block 166 of FIG. 5. If the well_number is greater than the total number of wells (X), then the loop is exited, as shown at block 168 of FIG. 5. Otherwise, the flow chart of FIG. 5 goes to block 154.

As discussed previously, one method to analyze the data in the newly created table is by first determining the “weights” for each of the reaction parameters 172. The reaction parameters may include amount of ingredients, types of ingredients, etc. Prior to execution of the program, the operator assigns “weights” based on importance of each reaction parameter. In this manner, the results of each of the wells can be assigned a total “score” by multiplying the reaction parameters by the “weights” and adding them. For example, if the types of ingredients and amount of ingredients are the two parameters of interest, and the type of ingredients is considered more important than the amount of ingredients (for example, if one of the ingredients in the perfume example is very expensive, it may factor in the analysis), the “weights” for each can be 0.8 and 0.2, respectively for each of the two parameters. Each of the results for an individual well can then be tallied 174. The well_number is set to 1, as shown at block 170. The well_number is incremented by 1, as shown at block 176 of FIG. 5. If the well_number is greater than the total number of wells (X), then the loop is exited, as shown at block 178 of FIG. 5. Otherwise, the flow chart of FIG. 5 goes to block 174. For parameters which are more desirable when they are lower in value, the result of multiplying the weight by the parameter can be inverted, and then added to the total to determine the “score.”

The entries can then be arranged based on the score, as shown at block 180. The processor 64 then displays the results of the raw data and the “scores,” as shown at block 182. At each step in the methodology, the display can be updated to inform the operator of the current reaction. For example, when the processor 64 commands or receives information from the synthesizer 12, the analyzer 40 or the robot 50, the display can be updated to indicate the current operation.

Based on the highest ranked “score,” the suggested bounds for the next set of experiments are determined 184, 186. For example, if the amount of organic solvent, enzyme and substrate so that the enzyme—substrate ratio is as low as possible and the substrate concentration as high as possible, the parameters of the well with the highest ranked “score” may be used as a base value for the temperature bounds for the next set of experiments. The suggested parameters are then displayed to the operator 188.

Automated process research can greatly reduce the amount of time and cost involved in the production of new biocatalysts and the optimization of their performances. In addition, APR can provide statistical response curves so that the enzyme activities are optimized. These optimized conditions are not easily be found by examining one variable at a time. The use of APR technology could result in an expansion of the biocatalysis field due to a decrease in the time constraints involved in this process.

### EXAMPLE

### Enantioselective Hydrolysis of (±)-Phenethyl Acetate Using ThermoCat E009

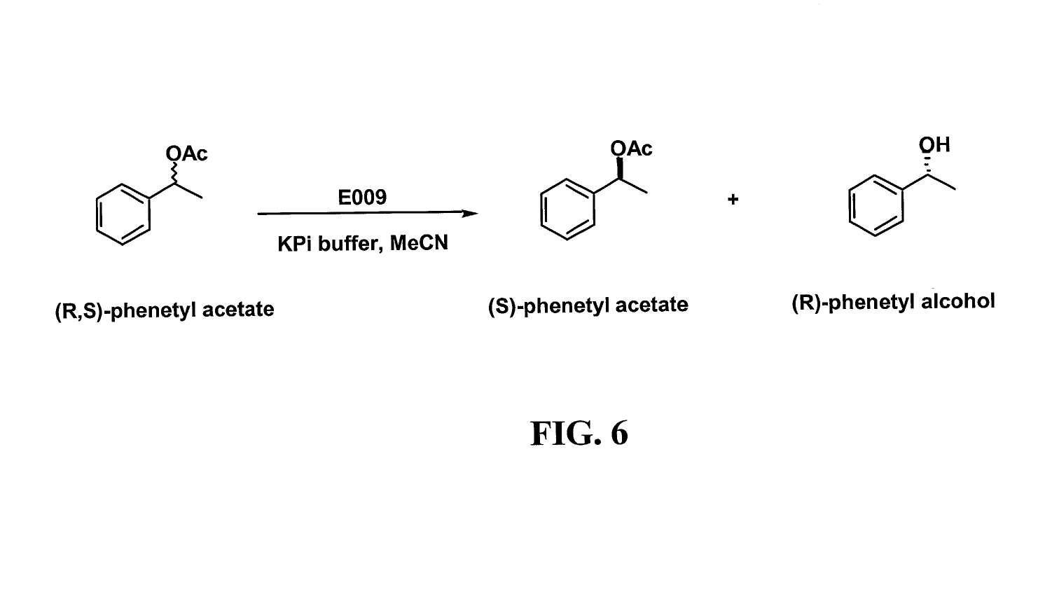

An enantioselective pair enzyme-substrate is selected as one example of the application of the DoE for purposes of process optimization. The enzyme is an esterase enzyme and the substrate is (±)-phenethyl acetate. The reaction that is being catalyzed is the Enantioselective hydrolysis of one enatiomer of the racemic acetate. Parameters to be optimized may include, for example, the amount of organic solvent, enzyme and substrate, so that the enzyme: substrate ratio is as low as possible and the substrate concentration as high as possible. The enzyme is enantioselective on all conditions tested as long as it keeps its activity. Referring to FIG. 6, there is shown the chemical reaction for the current example.

The set up consists of variable amounts of KPi buffer pH=7.2 containing bromothymol blue as a pH indicator, MeCN as cosolvent, E009 esterase (lyophilized powder) and racemic phenethyl acetate. Stirring is provided by a tumble stirring system that allows uniform mixing on a plate holding 8×12 glass vials as microreactors. pH is maintained around neutral by adding base upon color change in the reaction solution.

The first DoE contained 11 experiments involving 3 variables and 2 levels (the variable is given a high and a low value to evaluate the impact). The results indicated MeCN is the most critical factor, and a second DoE was set up using 14 experimental conditions to narrow down the MeCN variable (augmented design), involving again 3 variables and 2 levels. A third round of DoE (model-robust) contained 10 experiments involving the 3 variables and 2 levels, and a last DoE was performed (central-composite) again with 3 variables, 2 levels and 17 experiments. A total of 52 experiments were set up during the three rounds of Automated Process Research. Table 1 shows the experimental breakdown, 3 variables and 1 outcome.

TABLE 1

| | | | | |
|---|---|---|---|---|
| Exp | MeCN | E009 | [Sub] | conv. |
| # | (%) | (mg) | (mM) | (%) |

First

| | | | | |
|---|---|---|---|---|
| 1 | 5 | 30 | 200 | 70 |
| 2 | 5 | 5 | 5 | 64.7 |
| 3 | 50 | 30 | 5 | 0.7 |
| 4 | 50 | 30 | 200 | 0.1 |
| 5 | 50 | 5 | 5 | 2 |
| 6 | 5 | 30 | 5 | 100 |
| 7 | 50 | 5 | 200 | 0 |
| 8 | 5 | 5 | 200 | 32.3 |
| 9 | 28 | 18 | 103 | 0 |
| 10 | 28 | 18 | 103 | 1.6 |
| 11 | 28 | 18 | 103 | 0 |

Second

| | | | | |
|---|---|---|---|---|
| 1 | 1 | 5 | 5 | 67 |
| 2 | 12 | 30 | 5 | 88.9 |
| 3 | 4 | 24 | 54 | 86.9 |
| 4 | 9 | 11 | 151 | 60.8 |
| 5 | 7 | 18 | 103 | 71.2 |
| 6 | 12 | 30 | 5 | 100 |
| 7 | 1 | 18 | 200 | 71.9 |
| 8 | 7 | 18 | 103 | 71.9 |
| 9 | 4 | 24 | 151 | 84.6 |
| 10 | 1 | 5 | 5 | 64 |

Second augmented

| | | | | |
|---|---|---|---|---|
| 1 | 12 | 5 | 103 | 32.7 |
| 2 | 9 | 24 | 54 | 66.2 |
| 3 | 7 | 18 | 103 | 69.8 |
| 4 | 1 | 30 | 200 | 81.8 |
| 5 | 9 | 24 | 151 | 7.3 |
| 6 | 7 | 18 | 103 | 66.2 |
| 7 | 7 | 5 | 200 | 9.5 |
| 8 | 12 | 5 | 5 | 14.5 |
| 9 | 1 | 5 | 103 | 38.9 |
| 10 | 12 | 30 | 200 | 5.6 |
| 11 | 1 | 30 | 5 | 93.5 |
| 12 | 12 | 18 | 200 | 6.3 |
| 13 | 7 | 5 | 200 | 7.9 |
| 14 | 1 | 30 | 5 | 95.3 |

Third

| | | | | |
|---|---|---|---|---|
| 1 | 20 | 20 | 40 | 3.9 |
| 2 | 12 | 30 | 38 | 7.7 |
| 3 | 12 | 30 | 38 | 7 |
| 4 | 12 | 30 | 38 | 7.5 |
| 5 | 20 | 40 | 5 | 4.3 |
| 6 | 20 | 30 | 38 | 8 |
| 7 | 4 | 40 | 5 | 100 |
| 8 | 12 | 30 | 70 | 94.2 |
| 9 | 4 | 20 | 70 | 78.2 |
| 10 | 4 | 40 | 70 | 93 |
| 11 | 4 | 30 | 38 | 86.5 |
| 12 | 4 | 20 | 5 | 34.1 |
| 13 | 12 | 20 | 38 | 6.9 |
| 14 | 20 | 20 | 5 | 13 |
| 15 | 20 | 40 | 70 | 2.9 |
| 16 | 12 | 30 | 5 | 19.3 |
| 17 | 12 | 40 | 38 | 19.6 |

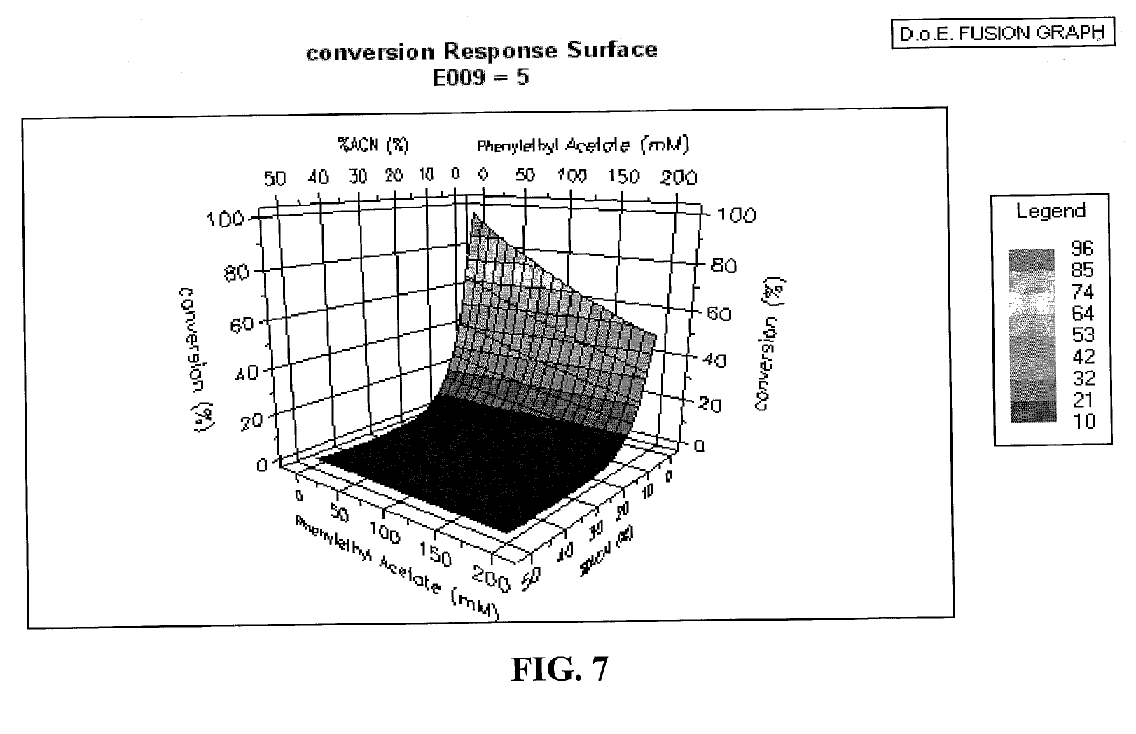

Referring to FIG. 7, there is shown a surface graph for two variables while one is fixed. In one case, the enzyme amount was fixed, in the other, substrate concentration. The first plot is the total screening space covered, while the second limits the amount of MeCN. One question for analysis is the optimum ratio enzyme-substrate. Since the enzyme is very enantioselective, the 50% conversion mark indicates where that optimum would be. From analysis of the results, the optimum appears to be 150 mM, 5 mg/2 mL of enzyme and 5-10% MeCN.

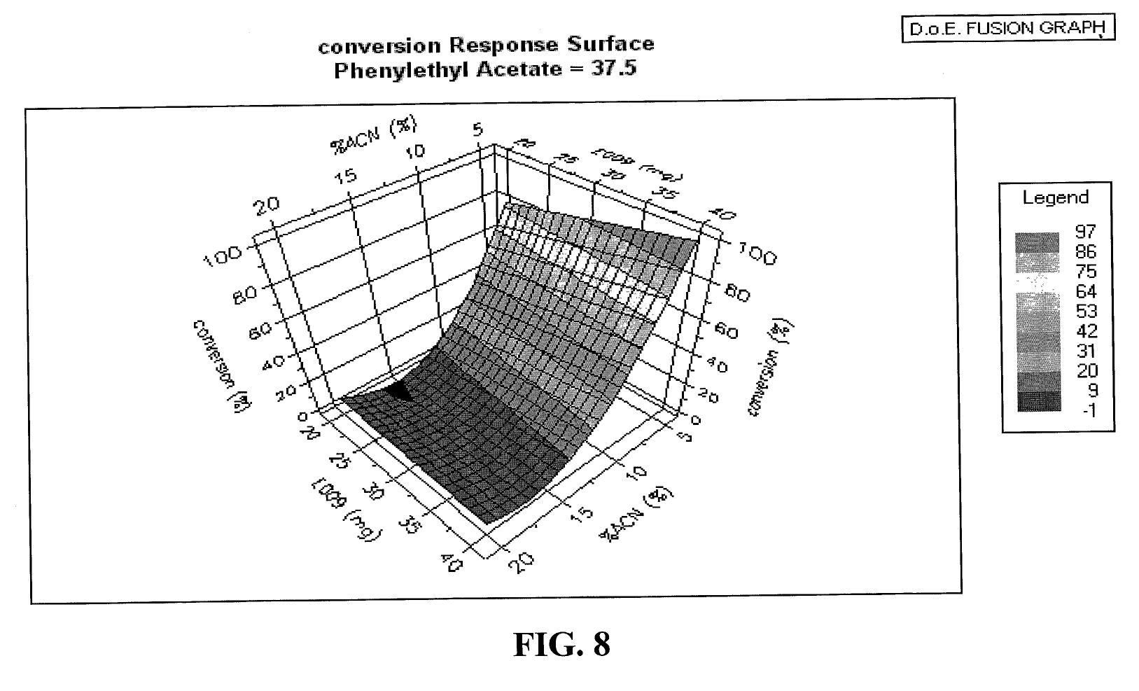

Referring to FIG. 8, there is shown the results of the second DoE or augmented design, and is a closer look at the response surface.

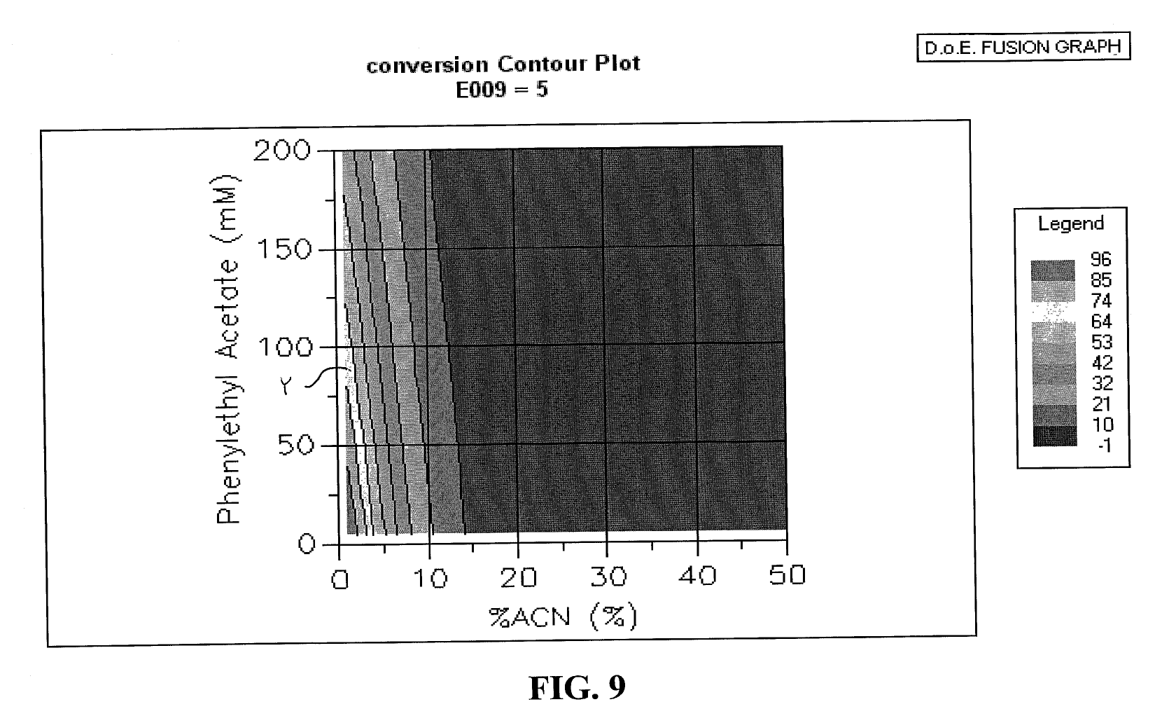

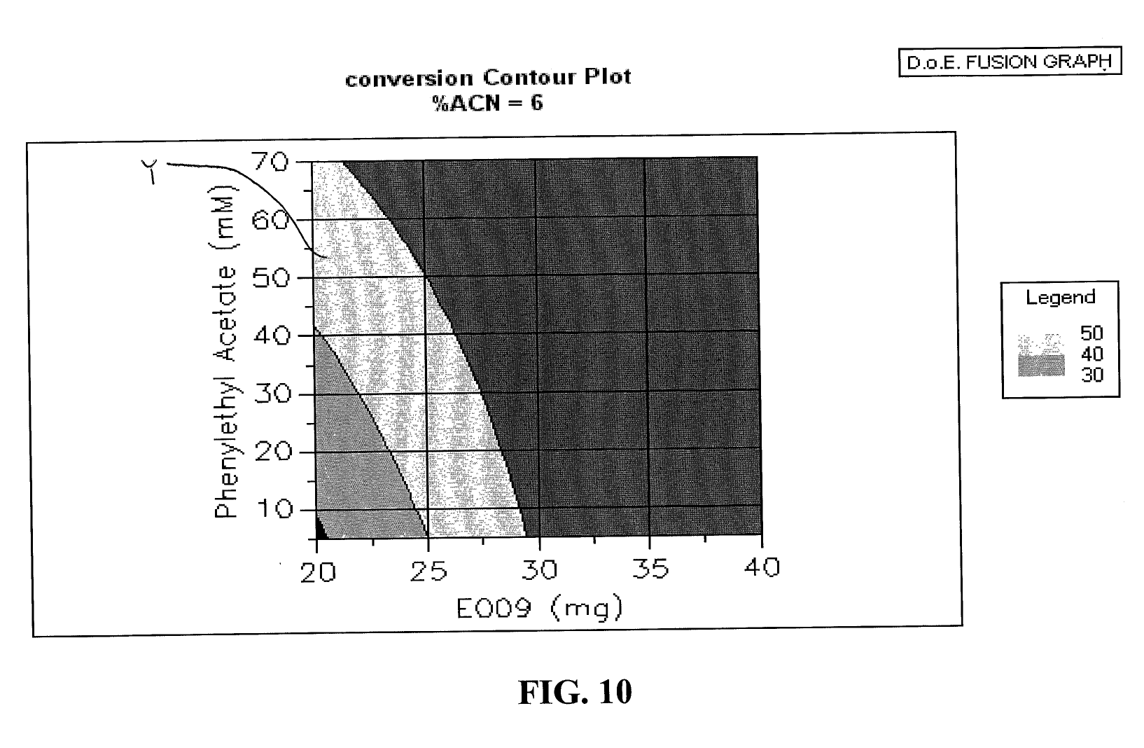

An alternative way of examining the data is the contour plots, shown in FIGS. 9 and 10, confronting enzyme and substrate at 5 and 6% MeCN. The area designated by “Y” is the target (50% conv) and the extrapolation indicates where to design the next set of experiments, which may use the ratio E/S as a variable rather than both parameters separately.

If the enzyme involved in the biotransformation needs to be improved in terms of enantioselectivity, the above method can be used to examine the enantioselectivity of the reaction around 50% conversion as the outcome, rather than the conversion itself.

It is intended that the foregoing detailed description be regarded as illustrative rather than limiting and that it is understood that the following claims, including all equivalents, are intended to define the scope of the invention.

What is claimed is:

1. A method for optimizing enzymatic resolution of a racemic mixture using a synthesizer, an analyzer and a computer, the method including the steps of:
identifying variables which affect enzymatic resolution;
choosing a finite number of experimental tests, wherein the experimental tests have values for the variables;
providing a plurality of wells;
assigning each of the experimental tests to a particular well;
dispensing reagents and solvents into a plurality of wells chosen from the values for the experimental tests;
enzymatically resolving in the synthesizer using operating conditions chosen from the values for the experimental tests;
obtaining at least a portion of contents from the plurality of wells;
analyzing to determine the magnitude of enzymatic resolution for the at least a portion of the contents from the plurality of wells;
automatically generating a statistical analysis using the computer based on the step of determining the magnitude of enzymatic resolution and at least one of the variables identified in order to evaluate the enzymatic resolution in the wells; and
automatically generating, using the computer, suggested parameters for future experiments based on the statistical analysis.

2. The method of claim 1, wherein one of the variables is type of enzymes.

3. The method of claim 2, wherein the variable for the type of enzymes is fixed.

4. The method of claim 1, wherein one of the variables is type of solvents.

5. The method of claim 4, wherein the solvents are selected from the group consisting of MeCN, MeOH, EtOH, DMF, H₂O, aqueous buffers and mixtures thereof

6. The method of claim 1, wherein one of the variables is pH.

7. The method of claim 1, wherein one of the variables is type of substrates.

8. The method of claim 1, wherein the step of analyzing to determine the magnitude of enzymatic resolution includes determining optical rotation of the at least a portion of the contents from the plurality of wells.

9. The method of claim 8, wherein the analyzer is a polarimeter.

10. The method of claim 8, wherein the analyzer is a chiral HPLC.

11. A method for selecting an optimal enzyme for carryout out an enzymatic transformation of a compound using a synthesizer, an analyzer and a computer, the method including the steps of:
identifying variables which affect enzymatic catalytic activity;
choosing a finite number of experimental tests, wherein the experimental tests have values for the variables;
providing a plurality of wells;
assigning each of the experimental tests to a particular well;
dispensing reagents and solvents into a plurality of wells chosen from the values for the experimental tests;
enzymatically transforming the compound in the synthesizer using operating conditions chosen from the values for the experimental tests;
obtaining at least a portion of contents from the plurality of wells;
analyzing to determine the magnitude of enzymatic transformation for the at least a portion of the contents from the plurality of wells;
automatically generating a statistical analysis using the computer based on the step of determining the magnitude of enzymatic transformation and at least one of the variables identified in order to evaluate the enzymatic transformation in the wells; and
automatically generating, using the computer, suggested parameters for future experiments based on the statistical analysis.

12. The method of claim 11, wherein one of the variables is type of enzymes.

13. The method of claim 11, wherein one of the variables is amount of enzyme.

14. The method of claim 11, wherein carrying out of the enzymatic transformation of a compound is the enzymatic resolution of a racemic mixture.

15. The method of claim 11, wherein the enzymatic transformation is a chemical transformation of a compound.

16. The method as claimed in claim 11, wherein the step of analyzing the samples using the analyzer includes determining the amount of product yield.

17. The method as claimed in claim 11, wherein the step of analyzing the samples using the analyzer includes determining the amount of unreacted compound.

18. The method as claimed in claim 11, wherein the step of automatically generating a statistical analysis includes ranking the plurality of wells based on the magnitude of enzymatic transformation.

19. The method as claimed in claim 11, wherein the step of automatically generating a statistical analysis includes determining a most favorable reaction in one of the plurality of wells based on the magnitude of enzymatic transformation.
